(19) United States
(12) Patent Application Publication
(10) Pub. No.: US 2024/0113481 A1
(43) Pub. Date: Apr. 4, 2024

(54) SAFETY ELECTRIC SOCKET AND PLUG SYSTEM WITH EASY USE AND MAGNETIC RETAINING

(71) Applicant: UNIVERSITA' DEGLI STUDI DI FIRENZE, FIRENZE (IT)

(72) Inventors: MICHELE MARCO TIZZA, FIRENZE (IT); ALESSANDRA RINALDI, FIRENZE (IT); ALBERTO REATTI, FIRENZE (IT)

(73) Assignee: UNIVERSITA' DEGLI STUDI DI FIRENZE, FIRENZE (IT)

(21) Appl. No.: 18/276,272

(22) PCT Filed: Dec. 28, 2021
(86) PCT No.: PCT/IT2021/050431

§ 371 Date: Aug. 8, 2023

(30) Foreign Application Priority Data
Feb. 8, 2021 (IT) 102021000002765

(51) Int. Cl. H01R 13/71; H01R 13/62

(52) U.S. Cl. CPC H01R 13/71; H01R 13/6205

(57) ABSTRACT

A system (1, 100) with socket (20, 120)/plug (10, 110) is described, designed to prevent access to the electrical phase contacts (32, 132) and neutral contacts (33, 133) of the socket (10, 120) when the plug (10, 110) is not inserted in the socket (20, 120), and designed to ensure a phase to phase and neutral to neutral connection, in which, inside the socket (20, 120) there is a contact holder element (30) which, following the insertion of the plug (10, 110), retracts and interacts with a system of inclined guides (25) obtained in a structural rear part (24, 124) of the socket (20, 120), causing a transversal movement of the electrical phase contacts (32, 132) and neutral contacts (33, 133), able to make a connection with the corresponding electrical phase contacts (13, 113) and neutral contacts (14, 114) present on the plug (10, 110).

### CROSS REFERENCE TO RELATED APPLICATION

The present application is a U.S. national phase application of a PCT Application No. PCT/IT2021/050431 filed on Dec. 28, 2021, which claims a priority to Italian Patent Application No. 102021000002765 filed in Italy on Feb. 8, 2021 a disclosure of which are incorporated in their entireties by reference herein.

### BACKGROUND OF THE INVENTION

### 1) Field of the Invention

The present invention refers to an electric socket and plug system, more precisely to an electric power module, and its related plug, provided with means designed to prevent access to the electric contacts of the socket when the plug is not inserted and with magnetic retention means to keep the plug inserted in the socket.

The particular shape allows not to have a predefined direction of insertion, ensuring ease of use and safety, even for users with motion and sensory disabilities (for example visually impaired).

### 2) Background Art

Current sockets have some drawbacks. Firstly, if one trips the electric wire, one risks breaking the electrical connections with the risk of short-circuiting and losing the socket protection. This happens because, in the event of a trip, the traction on the wire has a strong transverse component with respect to the direction of insertion/extraction of the socket.

Secondly, it is never possible to understand if phase and neutral are connected in the best way, i.e. phase of the socket with phase of the plug and neutral of the socket with neutral of the plug. There are devices that ensure this connection, but make use of grooved couplings that are difficult to insert, especially for users with motion and sensory disabilities.

Documents US-A1-2014/213093, US-A1-2016/261078, CA-A-101 714 732, CN-A-108 242 621, CN-A-108 206 394, EP-A1-2 357 708, GB-A-2 472 233, US-A1-2020/166202 and U.S. Pat. No. 5,759,069 disclose socket/plug systems according to the preamble of claim 1.

### SUMMARY OF THE INVENTION

Object of the present invention is providing a device capable of solving the aforementioned drawbacks.

The aforementioned and other objects and advantages of the invention, as will emerge from the following description, are achieved with a socket/plug system, in accordance with claim 1, in which:
access to the phase and neutral electrical contacts is prevented when the plug is not inserted in the socket;
the phase to phase and neutral to neutral connection is ensured.

This socket/plug system provides that, inside the socket, there is a contact holder element which, following the insertion of the plug, retracts and interacts with a system of inclined guides obtained in a structural rear part of the socket, causing a transverse movement of the electrical phase and neutral contacts, adapted to make a connection with the corresponding electrical phase and neutral contacts present on the plug.

Preferred embodiments and non-trivial variants of the present invention form the subject matter of the dependent claims.

In particular, the socket/plug system according to the invention provides for a magnetic retention of the plug, which ensures that the plug is kept in position, but allows avoiding damage to people and to the electrical connections in the event of a trip in the wire, as the magnetic force retention is not increased by pulling the wire that is not aligned with the direction of insertion/extraction of the plug.

Both the plug and the socket are cylindrical in shape, so it is never necessary to look for an insertion direction, as is the case with traditional sockets: therefore, it is easier for disabled people to use them. The cylindrical shape, combined with a particular arrangement of the contacts, guarantees a state of the art connection, i.e. phase to phase and neutral to neutral.

As for the passage of electric current, the socket accepts the plug, initially activating the earth connection. Only when the plug is close to the limit switch are the phase and neutral contacts uncovered, thus activating the passage of current. The contacts of the socket are therefore inaccessible (except for the grounding pole) until the plug is inserted.

The total dimensions of the socket are comparable to the power module of the socket called “Schuko” so that an insertion on the market does not require excessive distortions.

According to a preferred embodiment, the magnet present inside the socket is replaced by art electromagnetic coil which, through the use of a switch, allows for an electromagnetic holding field, which is therefore deactivated when the passage of current is interrupted thanks to the switch, allowing the socket to be released, without any type of restraint.

Through the use of magnets, it is possible to eliminate both the problems due to mechanical restraint, and the wear that this entails on the contacts under tension, as well as all problems related to stumbling mentioned above.

It is understood that all attached claims form an integral part of the present description.

It will be immediately obvious that innumerable variations and modifications (for example relating to shape, dimensions, arrangements and parts with equivalent functionality) can be made to what is described, without departing from the scope of the invention, as appears from the attached claims.

### BRIEF DESCRIPTION OF THE DRAWINGS

The present invention will be better described by some preferred embodiments thereof, provided by way of non-limiting example, with reference to the attached drawings, in which:

FIG. 1 shows an electric socket and plug system according to the present invention;

FIG. 2 (a, b) show the plug according to the invention in three orthogonal views and one perspective view;

FIG. 3 (a, b) show in section the socket according to the invention, respectively in its closed and open configuration;

FIGS. 4, 5 and 6 show the internal elements of the socket in three orthogonal views and one perspective view;

FIG. 7 shows a variation of the electrical socket and plug system according to the invention;

FIG. 8 (a, b) show respectively the plug and the socket according to the variation in FIG. 7.

### DETAILED DESCRIPTION OF PREFERRED EMBODIMENTS

In the following, the configuration according to which the electrical contacts are hidden, will be called “open”, the configuration according to which the electrical contacts are uncovered, will be called “closed”.

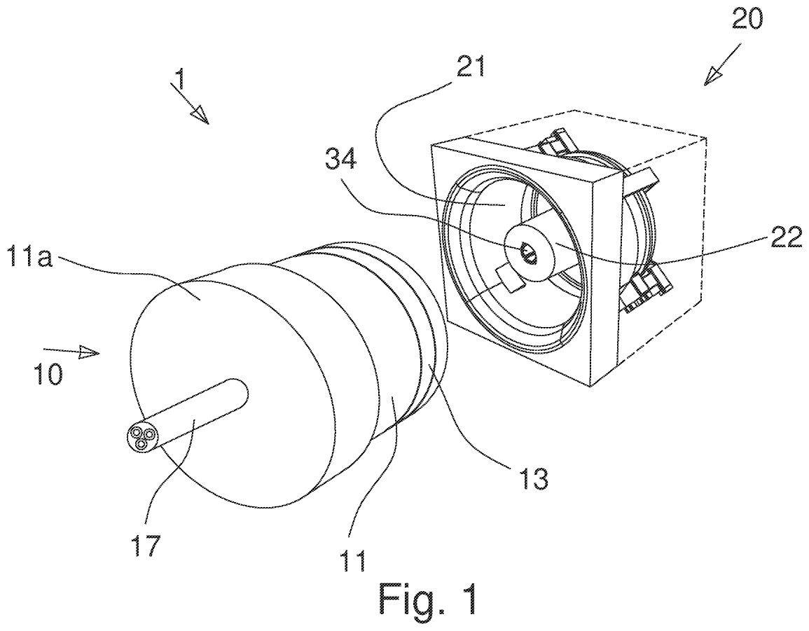

Referring to FIGS. 1, 2, 3 and 4, (1) designates a plug (10)/socket (20) system according to the invention.

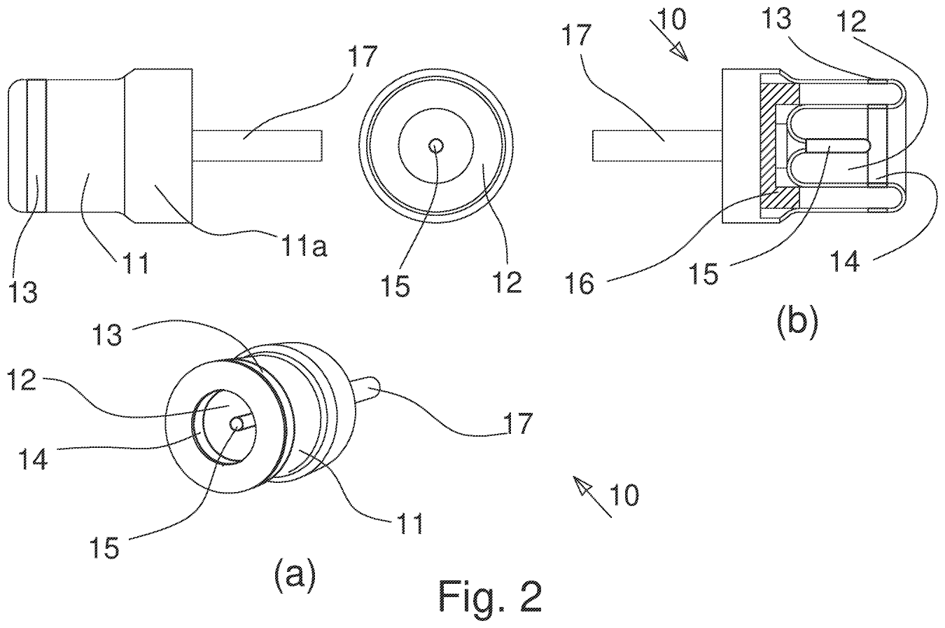

The plug (10) is shown according to two orthogonal views and a perspective view in FIG. 2. This plug (10) includes a cylindrical body (11) provided with a handle (11a). The cylindrical body (11) fits into a corresponding cavity (21) obtained on the socket (20). Furthermore, inside the cylindrical body (11) there is a cavity (12) (FIG. 2b) suitable for accommodating a protuberance (22) present in the socket (20).

On the external surface of the cylindrical body (11) there is a first contact (13) for the phase while on the internal surface of the cavity (12) there is a second contact (14) for the neutral and, in an axial position, a third contact (15) for the earth.

On the bottom of the cavity (12), but not accessible from the outside, there is a first magnet (16) intended to interact with a second and a third magnet (26, 27) present in the socket (20), in order to maintain the plug (10) in place when inserted into the socket (20).

From the side opposite to that in which the contacts (13, 14, 15) are present, a three-pole electric cable (17) comes out. The three cables inside the three-pole cable (17) are connected to the three contacts (13), (14) and (15) with known type terminals (not shown).

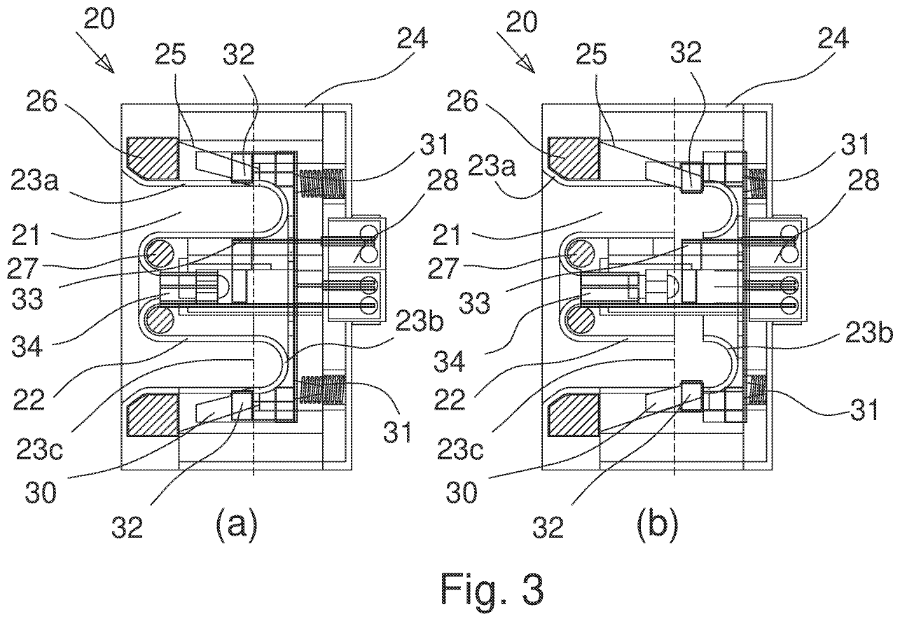

In FIG. 3 the socket (20) is shown in section. In particular, FIG. 3a shows the socket (20) in a “closed” configuration, i.e. with the electrical contacts hidden, when the plug (10) is not inserted. FIG. 3b shows the socket (20) in an “open” configuration, i.e. with the electrical contacts uncovered, when the plug (10) is inserted.

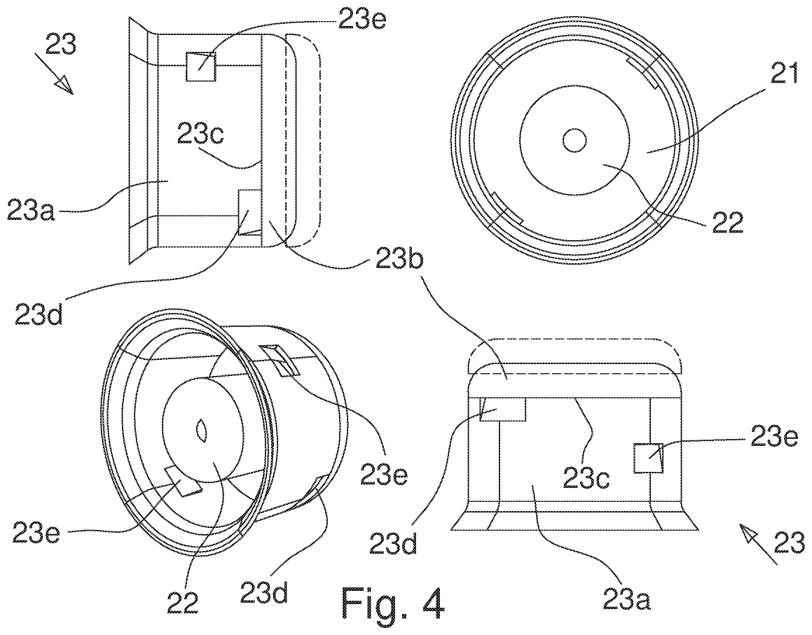

The socket (20) comprises a front part (23), shown in detail in FIG. 4, a structural rear part (24) and a contact holder element (30), which is inserted between the front part (23) and the structural rear part (24).

The front part (23) identifies the cavity (21) and the protuberance (22), which fits into the cavity (12) of the socket (20). The front part (23) is made of two parts: a front part (23a), including the protuberance (22), and a rear part (23b), separated by the dashed line (23c), so that, when the plug (10) is inserted into the socket (20), the bottom (23b) of the front part (23) retracts, together with the contact holder element (30) and uncovers the electrical contacts of the socket (20), the retraction causing a deformation of means rubber bands (31), as clearly shown in FIG. 3b.

Inside the front part (23) and the protuberance (22), the second and third annular magnets (26, 27) are respectively housed, intended to interact with the first magnet (16), housed inside the plug (10), so as to keep the plug (10) in position when in it is inserted into the socket (20).

The structural part (24) of the socket (20) comprises a first system of inclined guides (25) and a second system of inclined guides orthogonal to the first, which for this reason does not appear in the drawing of FIG. 3. The function of these guiding systems will be specified below.

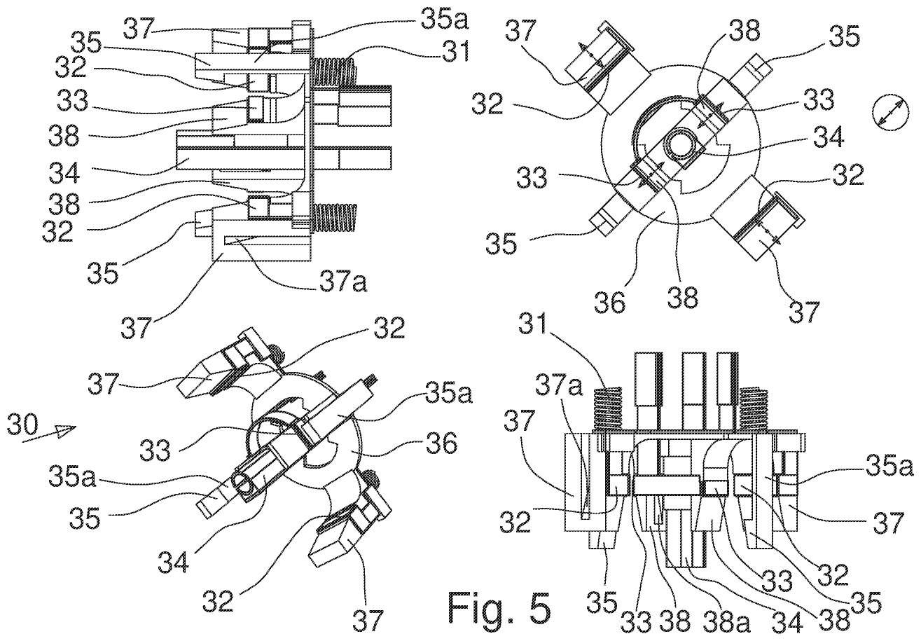

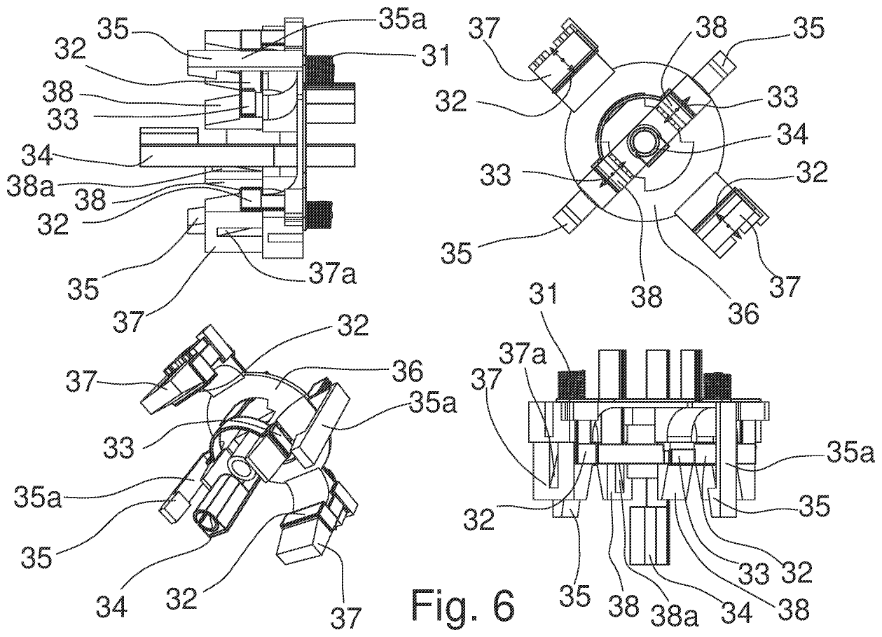

Between the front part (23) and the structural part (24) of the socket (20) there is housed the contact holder element (30), better shown in FIGS. 5 and 6, respectively in its “closed” and “open” configurations.

On the back of the structural element (24) there is a terminal block (28), electrically connected with the electrical contacts (32, 33, 34).

The electrical contacts present on the contact holder element (30), shown more clearly in FIGS. 5 and 6, are:
a first pair of contacts (32) for the phase;
a second pair of contacts (33) for the neutral;
an axial contact (34) for the earth.

FIG. 4 shows in three orthogonal views and a perspective view the front part (23), with highlighted the bottom (23b), drawn with a dashed line, which retracts due to the insertion of the plug (10).

On the side of the front part (23) a first pair of openings (23d) is made, positioned along the edge (23c), to make the first pair of electrical contacts (32) emerge. On the side of the front panel (23) there is also a second pair of openings (23e) in in which teeth (35), placed at the top of flexible rods (35a) forming part of the contact holder (30), snap into place.

The contact holder element (30) includes a base (36) on which a first and a second pair of supports (37) and (38) slide transversely, respectively for the phase (32) and neutral (33) contacts. Also connected to the base (36) are the flexible rods (35a), the ends of which are shaped so as to form the teeth (35). These teeth (35) are shaped in such a way as to be able to easily enter the openings (23e) obtained on the sides of the front part (23) of the socket (20), but to be able to exit with moderate stress, so as to effect a weak locking, adapted to improve the maintenance of the socket (20) in the closed position, cooperating with the elastic elements (31), but not preventing its opening following the insertion of the plug (10).

The locking operated by the teeth (35), although mild, is nevertheless essential to avoid inadvertent exposure of the contacts, or rather, to avoid inadvertently accessing the contacts under voltage by introducing an object into the cavity (21). In other words, the teeth (35) are safety devices, without which the socket (20) could not comply with minimum safety requirements.

On the first supports (37) inclined guides (37a) are formed which engage the first system of inclined guides (25), present on the structure (24) of the socket (20). The effect of the engagement is a transverse displacement of the first supports (37) of the phase contacts (32) following the retraction of the contact holder (30).

Similarly, inclined guides (38a) are formed on the supports (38) which engage the second system of inclined guides (not shown), present on the structure (24) of the socket (20). Also in this case, the effect of the engagement is a transverse displacement of the second supports (38) of the neutral contacts (33) following the retraction of the contact holder (30).

In practice, when the plug (10) is inserted into the socket (20), the bottom (23b) of the front part (23) moves back and, with it, the contact holder (30), overcoming the elastic reaction of the elastic elements (31) and causing the teeth (35) to come out of the openings (23e) at the same time. Due to the retraction of the contact holder element (30), the first and second systems of inclined guides (25) present on the structure (24) of the socket (20) interact with the inclined guides (37a), (38a) of the supports (37) of the phase contacts (32) and of the supports (38) of the neutral contacts (33), which move in a transverse direction, as indicated by the arrows, to come out into the open.

In particular, the supports (37) of the phase contacts (32) approach the axis of the socket (20), while the supports (38) of the neutral contacts (33) move away from it, so as to respectively come into contact with the phase contacts (13) and the neutral contacts (14) of the plug (10).

At the same time, the earth contact (15) of the plug (10) is inserted into the earth contact (34) of the socket (20). In these conditions, the first magnet (16) of the plug (10) is sufficiently close to the second and third magnets (26, 27) of the socket (20) to securely lock the plug (10) inside the socket (20).

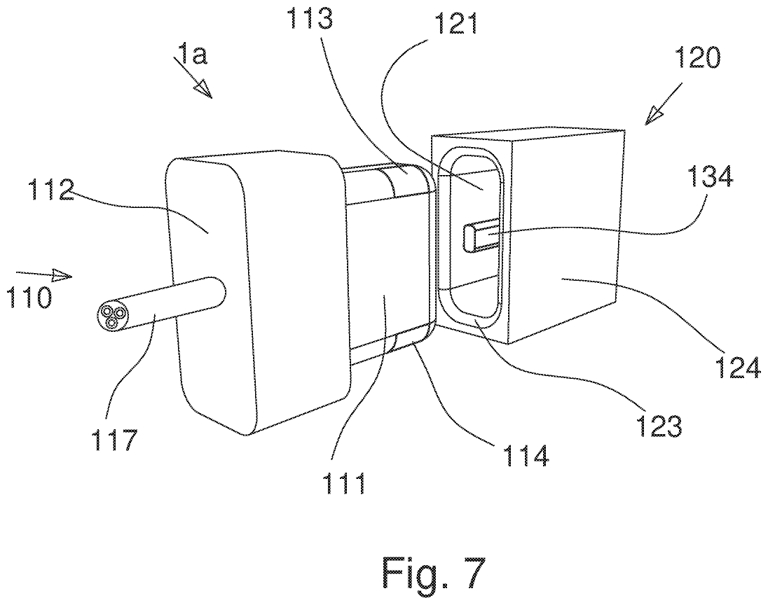

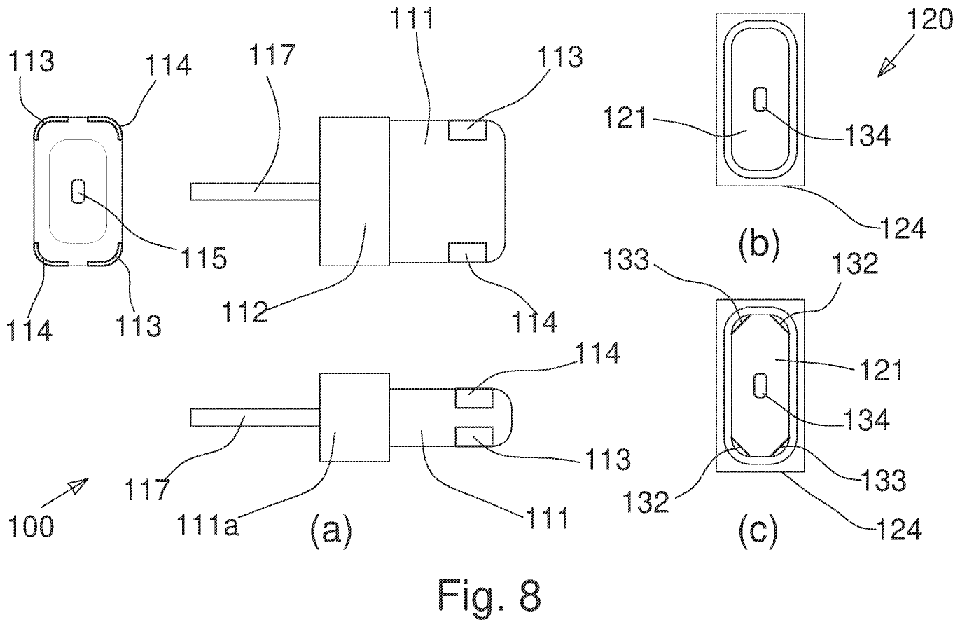

In FIGS. 7 and 8 a variation of the plug (110)/socket (120) system (100) according to the invention is shown.

The plug (110) comprises a body (111) provided with a handle (112). The body (111) fits into a corresponding cavity (121) made on the socket (120).

On the external surface of the plug body (111) there is a first pair of electric contacts (113) for the phase and a second pair of electric contacts (114) for the neutral. Furthermore, inside the body (111) there is, in an axial position, an earth contact (115) which connects with an earth contact (134) of the socket (120).

From the side opposite to that in which the contacts (113, 114, 115) are present, a three-pole electric cable (117) comes out. The three cables inside the three-pole cable (117) are connected to the three contacts (113), (114) and (115) with known type terminals (not shown).

In turn, the socket (120) comprises a front part (123), in which the cavity (121), a structural rear part (124) and the phase (132), neutral (133) and earth (134) contacts are made.

FIG. 8b shows the socket (120) in its closed configuration and FIG. 8c shows the same socket (120) in its open configuration, in which the phase (132) neutral (133) and earth (134) contacts are visible.

The phase contacts (113) for the plug (110) and the phase contacts (132) for the socket (120) are placed in diagonally opposite positions and the same is true for the neutral contacts (114) for the plug (110) and the neutral contacts (133) for the socket (120). In this way, in both possible insertion directions, the phase to phase and neutral to neutral connection is always ensured.

In the internal part of the socket (120) there is a contact holder element (not shown) which has the same functionality as the corresponding contact holder element (30) of the socket (20). Also in this case, the contact holder element is provided with supports for the phase and neutral (133) contacts which, following the insertion of the plug (110), retracts and, through a transversal movement of the supports of the contacts, makes the electrical connection with the corresponding contacts of the plug (110). This transverse movement is caused by an interaction between the inclined guides present on the contact holder supports (not shown) with corresponding inclined guides (not shown) present on the structural rear part (124) of the socket (120).

Finally, also in this variation, a magnetic retention system is preferably present.

The total dimensions of the sockets (20) and (120) are comparable respectively to the power modules of the “Schuko” and Italian commercial sockets, so that their commercialisation is facilitated.

1-11. (canceled)

12. A system with socket/plug, designed to prevent access to electrical phase contacts and electrical neutral contacts of the socket when the plug is not inserted in the socket, and designed to ensure a phase to phase and neutral to neutral connection;
wherein, inside the socket, there is a contact holder element which, following an insertion of the plug, retracts and interacts with a system of inclined guides made in a structural rear part of the socket, causing a transverse movement of the electrical phase contacts and the electrical neutral contacts, suitable for making a connection with corresponding electrical phase contacts and electrical neutral contacts present on the plug, the plug comprising:
a cylindrical body which is inserted into a corresponding cavity obtained on a front part of the socket, inside the cylindrical body a cavity being obtained;
a first phase contact positioned on an external surface of the cylindrical body;
a second neutral contact positioned on an internal surface of the cavity;
a third earth contact, axially positioned inside the cavity.

13. The socket/plug system of claim 12, wherein the socket comprises:
the front part;
the structural rear part;
the contact holder element, which is inserted between the front part and the structural rear part.

14. The socket/plug system of claim 13, wherein the front part comprises:
a first front part which identifies the cavity of the socket and comprises a protuberance which fits into the cavity of the plug;
a rear part, separated from the first front part, such that, when the plug is inserted into the socket, the rear part of the front part moves back, together with the contact-carrying element and uncovers the electrical contacts of the socket, the retraction causing a deformation of elastic means.

15. The socket/plug system of claim 14, wherein, on the side of the front part, a first pair of openings are made, positioned along an edge, through which the first pair of phase electrical contacts emerge.

16. The socket/plug system of claim 14, wherein, on the side of the front part, a second pair of openings are made, into which teeth, located at the top of flexible rods forming part of the contact holder, are snap inserted.

17. The socket/plug system of claim 12, wherein the contact holder element comprises a base on which a first and a second pair of supports transversally slide, respectively for the phase contacts and the neutral contacts, bringing the phase contacts closer to the axis of the socket and moving away the neutral contacts from the axis of the socket, so as to bring the phase contacts and the neutral contacts in connection with the respective phase contacts and neutral contacts of the plug, in which the sliding is due to the interaction of guides present on the supports with a first system of inclined guides present on the supports with a second system of inclined guides present on the rear structural element of the socket, when the bottom of the front part of the socket retracts and, with it, the contact holder element, overcoming the reaction of elastic elements, due to the insertion of the plug into the socket.

18. The socket/plug system of claim 17, wherein flexible rods are also connected to the base, the ends of which are shaped so as to form the teeth able to easily enter the openings obtained on the sides of the front part of the socket, but to come out with a moderate stress, so as to effect a weak locking, suitable to improve the maintenance of the socket in the closed position, cooperating with the elastic elements, but not preventing their opening following the insertion of the plug.

19. The socket/plug system of claim 12, having magnetic means, inside the plug and the socket, designed to interact in order to keep the plug inside the socket.

20. The socket/plug system of claim 19, wherein the magnetic means comprise a first magnet or electromagnet, inside the plug, and a second and a third magnet or electromagnet, inside the socket.
